(19) United States
(12) Patent Application Publication
(10) Pub. No.: US 2021/0195282 A1
(43) Pub. Date: Jun. 24, 2021

(54) XDI Systems, Devices, Connectors and Methods

(71) Applicant: Luxi Electronics Corp., Irvine, CA (US)

(72) Inventor: Xiaozheng Lu, Irvine, CA (US)

(21) Appl. No.: 16/762,438

(22) PCT Filed: Nov. 7, 2018
(86) PCT No.: PCT/US18/59693

§ 371 Date: May 7, 2020

Related U.S. Application Data
(60) Provisional application No. 62/583,867, filed on Nov. 9, 2017.

(51) Int. Cl. H04N 21/4363; H04N 21/4402; H04N 21/845; H04N 21/81

(52) U.S. Cl. CPC H04N 21/43632; H04N 21/816; H04N 21/8458; H04N 21/440263

(57) ABSTRACT

The invention provides systems, devices, connectors and methods to send compressed audio video serial digital signals thru local systems with significantly reduced bandwidth requirements and device costs, over longer cable runs and with higher system flexibility (i.e. connection topologies and scalability), with much simpler and installation friendly single coax cables and connectors, without introducing any signal quality losses or delays comparing to the current uncompressed digital systems like HDMI, DVI, DP or SDI when using the already compressed audio video content. The invention also provides solutions for integrating the uncompressed audio video content and Internet content into this system. These systems, devices, connectors and methods are collectively called “XDI” (Extended Digital Interface).

### CROSS-REFERENCE TO RELATED APPLICATIONS

This application claims the priority of U.S. Provisional Application No. 62/583,867 filed Nov. 9, 2017, which is incorporated into this application in its entirety by this reference.

### FIELD OF THE INVENTION

The invention relates to a new audio video standard that uses compressed audio video data in serial digital format that can transmit 4k, 8k video (and beyond) signals over very long distances using low cost coax copper cables, and electronic devices configured with circuitry for the compressed audio video data with very low bandwidth requirements for much lower costs and increased reliability, as well as providing for flexible system topologies (star or daisy chain or mixtures thereof). This new standard and its associated electronic devices will provide identical audio video qualities as the current uncompressed standards like HDMI (High-Definition Multimedia Interface), DVI (Digital Visual Interface), DP (DisplayPort) and SDI (Serial Digital Interface). This standard includes hardware and software innovations in systems, devices and components, and collectively is called the “XDI” (Extended Digital Interface) standard.

### BRIEF DESCRIPTION OF THE DRAWINGS

FIG. 1 schematically shows an example illustration of a video audio system representing prior art uncompressed digital formats like HDMI, DVI, DP or SDI. The prior art system uses the signals of the highest native resolution among the connected displays, resulting with some displays having no pictures or scaled down pictures of reduced resolution. This system also suffers from very short cable runs between devices and very high device costs due to the excessive signal data rate required.

FIG. 2 schematically shows an example illustration of a video audio system representing prior art uncompressed digital formats like HDMI, DVI, DP or SDI. The prior art system uses the signals of the lowest native resolution among the connected displays, resulting with some displays having pictures scaled up from a resolution much lower than their native resolution resulting in reduced resolution images. This system also suffers from short cable runs between devices and high device costs due to the excessive signal data rate required.

FIG. 3 schematically shows an example illustration of a video audio system with an embodiment of the current invention for the XDI system with compressed audio video serial digital signals in a star topology. The cable run can be much longer and the device cost is much lower due to dramatically lower signal data rate being required. Each display reconstructs the video to its optimized native resolution.

FIG. 4 schematically shows an example illustration of a video audio system with an embodiment of the current invention for the XDI system with compressed audio video serial digital signals in a daisy chain topology. The cable run can be much longer and the device cost is much lower due to dramatically lower signal data rate being required. Each display reconstructs the video to its optimized native resolution. Also, a central switching device is not needed, the system is easier to install and the number of devices are scalable in live plug and play scenarios.

FIG. 5A schematically shows an example illustration of the front panel (top) and rear panel (bottom) of an embodiment of the current invention for a XDI Internet Streaming STB (Set Top Box).

FIG. 5B schematically shows an example illustration of a circuit block diagram of an embodiment of the current invention for a XDI Internet Streaming STB.

FIG. 6A schematically shows an example illustration of the front panel (top) and rear panel (bottom) of an embodiment of the current invention for a XDI Cable TV STB.

FIG. 6B schematically shows an example illustration of a circuit block diagram of an embodiment of the current invention for a XDI Cable TV STB.

FIG. 7A schematically shows an example illustration of the front panel (top) and rear panel (bottom) of an embodiment of the current invention for a XDI Satellite TV STB.

FIG. 7B schematically shows an example illustration of a circuit block diagram of an embodiment of the current invention for a XDI Satellite TV STB.

FIG. 8A schematically shows an example illustration of the front panel (top) and rear panel (bottom) of an embodiment of the current invention for a XDI 8k Blu-ray Player.

FIG. 8B schematically shows an example illustration of a circuit block diagram of an embodiment of the current invention for a XDI 8k Blu-ray Player.

FIG. 9A schematically shows an example illustration of the front panel (top) and rear panel (bottom) of a current invention XDI Hard Drive Player/Recorder.

FIG. 9B schematically shows an example illustration of a circuit block diagram of an embodiment of the current invention for a XDI Hard Drive Player/Recorder.

FIG. 10A schematically shows an example illustration of the front panel (top) and rear panel (bottom) of an embodiment of the current invention for a XDI Compression Encoder/3×1 Switcher.

FIG. 10B schematically shows an example illustration of a circuit block diagram of an embodiment of the current invention for a XDI Compression Encoder/3×1 Switcher.

FIG. 11A schematically shows an example illustration of the front panel (top) and rear panel (bottom) of an embodiment of the current invention for a XDI Compression Decoder/1×3 Splitter.

FIG. 11B schematically shows an example illustration of a circuit block diagram of an embodiment of the current invention for a XDI Compression Decoder/1×3 Splitter.

FIG. 12A schematically shows an example illustration of the front panel (top) and rear panel (bottom) of an embodiment of the current invention for a XDI 4×4 Node (32×32 Matrix Switcher).

FIG. 12B schematically shows an example illustration of a circuit block diagram of an embodiment of the current invention for a XDI 4×4 Node (32×32 Matrix Switcher).

FIG. 13A schematically shows an example illustration of the rear panel of an embodiment of the current invention for a XDI display (TV or projector) I/O (Input/Output) portion.

FIG. 13B schematically shows an example illustration of a circuit block diagram of an embodiment of the current invention for a XDI display (TV or projector) I/O (Input/Output) portion.

FIG. 14A schematically shows an example illustration of two removable sleeves, one connector core and one female jack of an embodiment of the current invention for Micro Coaxial Cable Connectors.

FIG. 14B schematically shows an example illustration of alternative Micro Coaxial Cable male and female Connectors where the male connector rear flange is inserted into the coax wire by pushing and crimping or by screwing into the coax wire, and the front probe is locked in place into the female connector by raised lips on male connector and a matching groove in female connector.

FIG. 15 schematically shows an example illustration of a software flowchart of an embodiment of the current invention for Link Bandwidth Management.

FIG. 16 schematically shows an example illustration of a software flowchart of an embodiment of the current invention for Dynamic Vector and Motion Based Video Compression.

### BACKGROUND

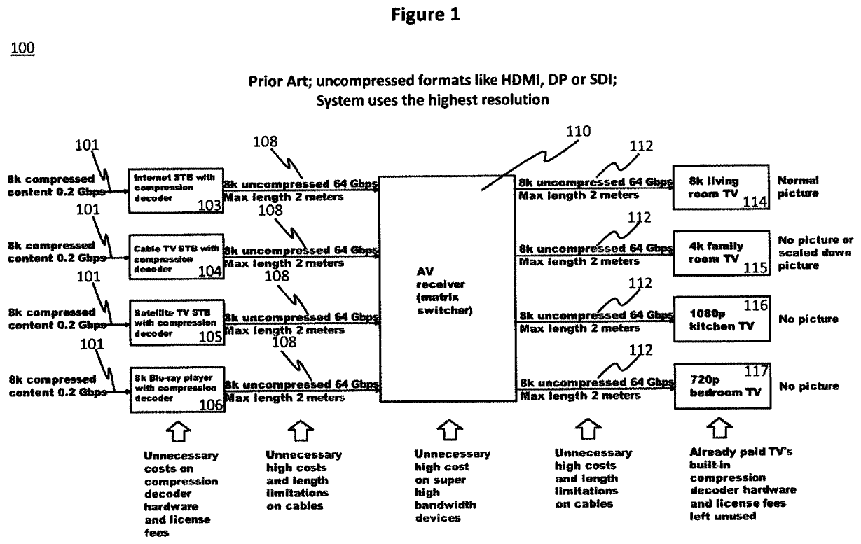

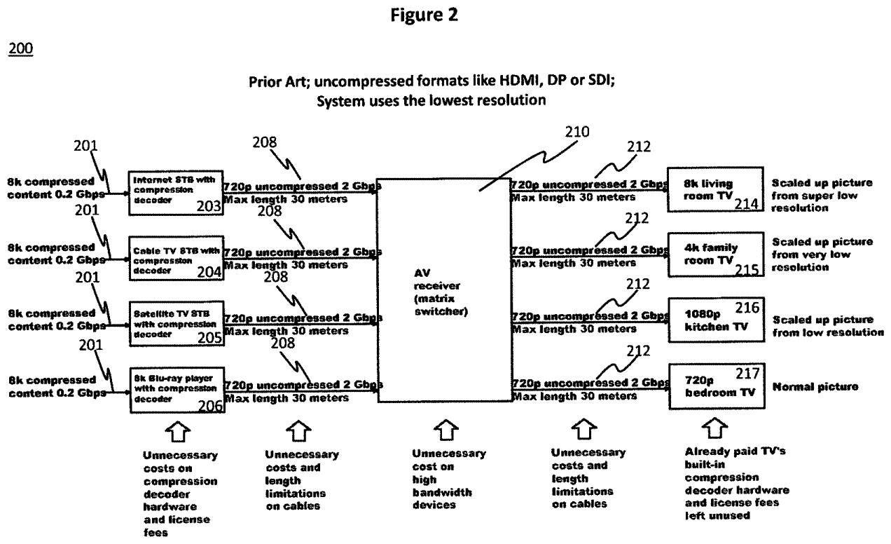

The current popular digital audio video standards of HDMI, DVI, DP and SDI all use uncompressed signals. The advantage of using uncompressed signals is that there is no signal quality loss. However with the rapid increasing demand and use of higher video resolution year after year, these uncompressed standards are increasingly not able to handle these super high data rates (an uncompressed 8k 60 Hz 4:4:4 signal data rate is 64 Gbps!). Further, here are limitations for such prior art systems
1) Cable length limitations: at 64 Gbps, the longest usable length of a copper cable is less than 2 meter. Even the shortest connections may require the much more expensive fiber cables which is often prohibitive commercially. See FIG. 1.
2) High device bandwidth requirement and costs: at 64 Gbps, the Integrated Circuit (IC) chips needed to make the devices useable become very expensive, and the Printed Circuit Board (PCB) layout design becomes very difficult (See FIG. 1).
   In addition to bandwidth related issues, the current standards also have other challenges:
3) System reliability and compatibility problems: higher the signal data rate, shorter the usable cable length. If the signal data rate sent from a HDMI, DVI, DP or SDI device exceeds the maximum bandwidth of that physical link (cable), the downstream sink won't get any signal, and the system breaks down. (FIG. 1 and FIG. 2)
4) No clean solution for mixed display resolutions: the video signals are pixel based with fixed resolution, and such a prior art system can only send one resolution at a time. When a system has several displays with different native resolutions, the system must choose one resolution. If the system chooses the highest resolution among displays as the signal resolution, then the other displays with lower resolutions would either get a scaled down picture or no picture (FIG. 1). If the system chooses the lowest resolution among the displays as the signal resolution, then the higher resolution displays would show the pictures scaled from much lower resolution (FIG. 2).
5) Lack of field termination and connector locking: HDMI, DVI and DP have multiple conductors inside the cable which makes field termination with connectors difficult. HDMI does not have locking features in the connector, making it unreliable for critical applications.
6) Star topology and difficulty of installation: all these standards use star topology, in which all source devices and displays are connected to a central switching device. This star topology often requires long cable runs, and a bundle of cables to go down from the conference table to underground and inside the wall. Also because any given model of matrix switcher has a fixed number of inputs and output, manufacturers have to make over a thousand different switcher models with different input and output numbers and formats to fit all needs.
7) Many conductors in a cable: HDMI, DVI and DP are semi parallel digital systems, having 19, 18 and 20 conductors (wires) respectively. This makes the connector termination more difficult as discussed in point 4 above, and also the cable construction, circuit and PCB design more difficult.
8) Extra compression hardware and license costs: currently, almost all TVs and projectors have built-in compression decoder circuits, and license fees are required for these technologies. However, in an uncompressed signal HDMI, DVI, DP or SDI system, these built-in compression decoder circuits are not used. The uncompressing is done in the built-in compression decoder circuit inside the source devices, incurring an extra set of hardware and license costs.
9) Not Internet friendly: because the audio video contents sent through the Internet are compressed, the local HDMI, DVI, DP or SDI signals are uncompressed, the data rate of the latter is hundreds of times bigger than the data rate of former, so there's no easy way to send local HDMI, DP or SDI through the Internet unless the very expensive compression encoders used.

In HDMI, DVI, DP or SDI systems, the source devices (Internet Streaming STB, Cable TV STB, Satellite TV STB, Blu-ray Player, Hard Drive Player/Recorder etc.) first uncompress the signals, then send the high data rate signals through the local systems to the displays. However, most of the source audio video contents from the Internet, Cable TV, Satellite TV, discs, and hard drives are all compressed contents. Decompressing the audio video signals in the source devices or in the displays makes zero difference in the signal quality and delay. In this case, the compressed signal local systems do not have any disadvantages because the original contents are also already compressed. However because the data rate of a compressed audio video is many hundreds times smaller than a uncompressed signal, the bandwidth requirements for a compressed signal local system is reduced by hundreds of times. Embodiments of the current invention of the XDI standard takes full advantage of compressed audio video content and the XDI system sends the compressed signals through the local systems all the way to the displays to have the signal uncompressed in the displays.

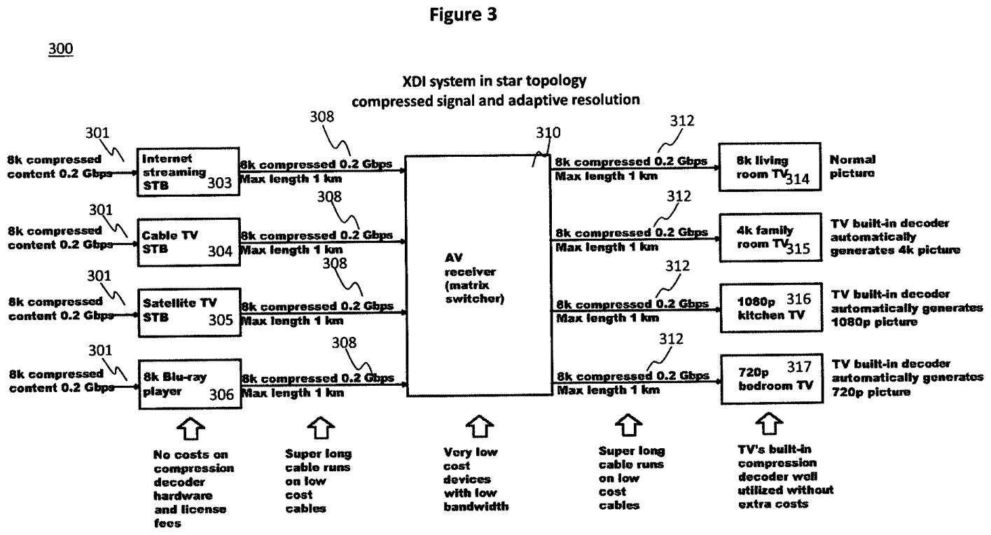

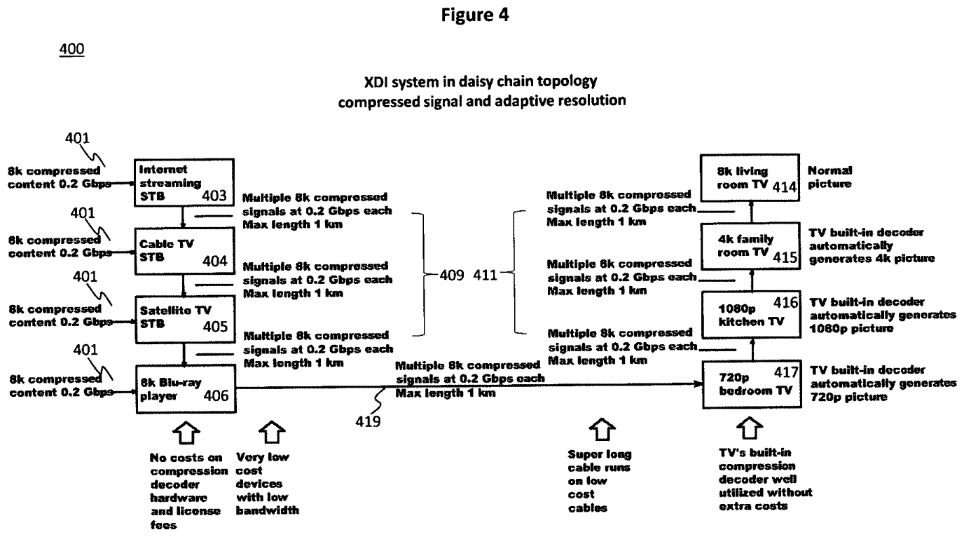

Here are the advantages of embodiments of the current invention XDI standard:
1) Very low cable costs and very long cable runs: with the signal data rate reduced by hundreds of times, cheap, reliable and readily available copper cables now can send 8k video signals to as long as 1 km away (See FIG. 3 and FIG. 4).
2) Very low device bandwidth requirement and costs: similarly, with the signal data rate bandwidth costs are reduced by hundreds of times, the cost of ICs and other components are much lower, and the PCB layout design is much easier also lowering costs for manufacturing.
3) High system reliability and compatibility: the current invention includes a system-wide link bandwidth management protocol that tests the maximum bandwidth of every physical link in a system live, and records these data, and makes sure the signal data rate sent through any physical link never exceeds the maximum bandwidth of that link. This ensures high reliability and compatibility throughout the XDI system.
4) Clean solution for systems with mixed display resolutions: embodiments of the current invention includes a dynamic vector and motion based video content compression algorithm that only sends the video content requested by the displays and also that is allowed by the physical link. The compression decoder inside the display reconstructs the video to its native resolution, and each display shows the optimal video to its own specifications.
5) Very easy field termination and native locking connectors: the current invention XDI standard uses the widely available coaxial wires and connectors which are very easy to use for field termination with connectors and also have native locking connector features. The current invention also includes an embodiment for a new micro coaxial connector system that carries the same advantages yet still allows use with and fits the very thin profile of portable devices like smart phones, tablets and the like.
6) Flexible topologies and ease of installations: the current invention enables the XDI systems to be connected in a star topology, daisy chain topology or a mixture of star and daisy chain configurations, greatly increased the flexibility of the installations. In the daisy chain topology, all the user needs to do is to use short patch cords to link the adjacent devices in the easiest route, and link as many as needed at any time, the system does the full matrix switching without the need for matrix switcher. A multiple user conference table with the XDI system only needs one small cox cable carrying the signals of all users on the table to run to the projectors.
7) Serial data with only one conductor in cables: the current invention uses serial data, and coaxial cables for all connections. This greatly simplifies the field termination and circuit design. It can also use Category cables, USB cables, wireless and other means of connections.
8) No extra compression hardware and license fees: since all signal decompressing is performed by the TV's built-in compression decoder, no compression decoder hardware is needed inside the source devices and obviating licensing requirements.
9) Internet friendly: in current invention, the audio video content from Cable TV STB, Satellite STB, Blu-ray Player, Hard Drive Player/Recorder use a similar compression method (H.264 or H.265) as the one used by Internet content providers, and with similar (very low) data rates. This makes streaming local compressed content over Internet very easy.

Some of the prior art devices compress the HDMI, DVI, DP or SDI signals to lower data rate, then send through Internet, then decompress at the far end. This compression will introduce significant signal quality loss and delay, making it a far inferior solution to embodiments of the current invention XDI systems that utilizes the already compressed source contents and with zero quality loss and delay.

The newly proposed HDMI, HDBT and DP revisions use the light intra-line compression to achieve the 3:1 compression in dealing with the 4k and 8k video challenges. Although such compression is lossless in most cases, the light 3:1 compression still does not solve the very high signal data rate problem completely, and still requires very high device and cable bandwidth (like the 48 Gbps proposed in HDMI 2.1), all the 9 problems mentioned before stand.

The prior art compressions are performed in parallel data, the prior art SDI system uses serial data yet no compression. Applying compression data in a serial data environment requires Serial Data to and from Parallel Data Conversions included in the current invention. In addition, the current invention further adds Bandwidth Manager to measure each link's actual bandwidth and manage the compression ratio via the Compression Controller so the signal data rate does not exceed the link bandwidth, and Daisy Chain Processor to manage the multiple serial data feeds in one cable. All these elements are not present in any prior art or their combinations.

The prior art SDI system is a serial digital format without HDCP (High-bandwidth Digital Content Protection), it's suited the broadcast and video production applications very well, however it does not fit the professional and consumer electronics applications due to the lack of content protection. The current invention XDI is built on the base of SDI, adds the HDCP along with compression, multi-feed daisy chain, power over XDI, bandwidth management, compression controller, results in a much robust, economical, flexible and reliable new standard. All these elements are not present in prior art SDI.

### SUMMARY

A serial digital system, methods, and software for compressed audio video signals collectively called “XDI” are provided in numerous embodiments. The serial digital systems comprise of at least one XDI source device and one XDI display device connected by at least one coaxial cable. The original audio video contents are in a compressed format. The system transmits the compressed audio video signal in a serial digital format. This compressed signal is uncompressed by the display device's built-in compression decoder before being shown on the screen.

In other embodiments there can be additional XDI source devices, switching and distribution devices, streaming devices and display devices in the system connected by multiple coaxial, fiber optic cables, wireless or wired network connections with compressed audio video signals in serial digital format.

In other embodiments when uncompressed digital audio video signals need to be transmitted through this compressed serial digital XDI system, there can be a XDI Compression Encoder that compresses signals and converts them to a serial digital format, and/or XDI Compression Decoder that converts serial digital signals for parallel and decompresses signals to an uncompressed format, in the system.

In one embodiment the devices in a XDI system are connected in a Star topology where all source devices are connected directly to a central matrix switcher, and all display devices are connected directly to that central matrix switcher.

In other embodiment the devices in a XDI system are connected in a Daisy Chain topology where all devices are connected in a series without any central switcher.

In yet other embodiments the devices in a XDI system are connected in a mixture of Star and Daisy Chain topologies.

In some embodiments the XDI devices have the HDCP circuits and software when the content protection is required. HDCP circuits and software represent alternate embodiments where these are incorporated into the devices and methods as set forth in the figures and elsewhere in this specification.

All XDI devices comprise circuit boards with MCU (Micro Control Unit) and its associated Memory to control all the local operations inside the device and to control all system wide operations with other connected devices.

All the XDI devices also comprise circuit boards with EQ (Equalizer) circuitry that amplifies and reshapes the signals and circuitry for a Bandwidth Manager that measures the physical link bandwidth and makes sure the signal data rate never exceeds the target bandwidth; circuitry for a POX (Power over XDI) that provides the remote power capability over the same single coaxial cable; circuitry for a Compression Controller that works with the Bandwidth Manager to send or request the right amount of audio video content data that is requested by the displays and that will not exceed the physical link's maximum bandwidth.

All the XDI devices that support the Daisy Chain features further contain at least one XDI input and at least one XDI output. On the circuit board inside these devices, there are circuitry for an EQ and a Bandwidth Manager; a POX; a TDM (Time Domain Multiplexing) de-Mux (de-Multiplexer) that converts one serial data stream with multiple sets of independent audio video signals into multiple serial data streams each with one set of independent audio video signals; circuitry for a Daisy Chain Processor (matrix switcher) that selects which upstream serial streams to bypass to the downstream devices and which one is replaced by local signal stream, or which upstream serial signal is extracted to local circuit to be converted and shown on connected local display; circuitry for a TDM Mux (Multiplexer) that combines multiple individual serial streams into one serial stream with multiple sets of independent audio video signals; and circuitry for another EQ and Bandwidth Manager.

In other embodiments the system can comprise an XDI Node device with at least one XDI input and at least one XDI output. The embodiment comprising multiple inputs and one output is called a switcher. The embodiment comprising one input and multiple outputs is called a splitter. The embodiment comprising multiple inputs and multiple outputs is called a matrix switcher. All these embodiments contain circuit board inside with circuitry for EQ, Bandwidth Manager, and several TDM de-Mux, after which all the independent audio video sets from all XDI inputs are separated into multiple serial data where each contains one set of audio video content. The signals are all fed into a matrix switcher to select which serial stream goes where. After the matrix switcher, several, TDM Mux, each combines several serial streams together into one serial stream with multiple sets of audio video contents, and feeds them into several EQ/Bandwidth Managers to be sent to downstream devices.

Embodiments of the current invention also comprises a set of micro coaxial male and female connectors. The male connector fits the same RG179 coax cable as the prior art DIN 1.0/2.3 connector does, but with a much smaller connector height to fit the very thin profile of devices like the smartphone, tablet or other such devices. The male connector consist a connector core for electrical contacts, and a removable sleeve for mechanical locking. The connector core comprises 3 components, the center conductor pin from the coax wire for signal contact, the inner ring pushed in between the coax wire's inner insulation and braiding for ground contact, and the outer ring crimped over the coaxial wire's outer jacket for mechanical bonding. Embodiments include two types of removable sleeves, one with the round cylinder for locking into the female DIN 1.0/2.3 connector; the other with left and right hooks for locking into the current invention female micro coax connector. These two sleeves have common features: an open slot along the length of the sleeve for the coaxial wire to slide into. Once the coaxial wire sliding in from the side, the removable sleeves slides forward along the coax wire onto the connector core, and semi-locks in the detain position by the shallow groove around the connector core and the shallow bump ring along the inner side of the sleeves. In scenarios where there is an accidental pull, the removable sleeve is the first point to break to protect the expensive devices on the female side of the connection, and the coaxial wire and male connector core, and can be replaced easily at low cost.

Embodiments of the current invention further comprises an alternative set of micro coaxial male and female connectors where the male connector rear flange is inserted into the coax wire by pushing and crimping or by screwing into the coax wire, and the front probe is locked in place into the female connector by raised lips on male connector and a matching groove in female connector. In such embodiments for male connector and female connector for coaxial wires, the male connector has a cylinder shaped probe with an inner and outer surface with a front end and a rear end, wherein the front end the outer surface has a raised lips of the surface and the female connector has a cylinder shaped receptacle with an inner and outer surface with a front end and a rear end, wherein the rear end's inner surface has a groove cut through the surface and wherein the raised lips of the male connector fall into the groove of the female connector when the male connector is inserted fully to form a mechanical lock.

The software for the Link Bandwidth manager at the XDI input and output circuit of every device has the functions of measuring the link bandwidth and managing the signal data rate. At the system initial power up, new connection or by request, the Bandwidth Manager in the upstream device pings the Bandwidth Manager in the downstream device. If no response, the Bandwidth manager will mark no device downstream. If there's a response, it will start sending test signals starting from the lowest data rate of 10 Mbps, and see if the downstream device responds with a correct answer. If so, it will test at 100 Mbps, and repeats until no response or correct response. Then it will mark the previous data rate with correct response as passed, then repeat the test of the 2, 3, 4, 5, 6, 7, 8 and 9 times of that data rate, and find the last (maximum) data rate with the correct response. Then this data rate is recorded as the max bandwidth for this link and registered with all devices in the system. Once all link maximum bandwidth is recorded, the Bandwidth Manager will process the signal data rate requests from all displays, compare it with the maximum bandwidth for all links in between, and decide if that data rate can pass through. If not, it will work with the Compression Manager circuits in the source devices to reduce the signal data rate. This process also manages the number of signal feeds through each link in the daisy chain enabled devices.

The Compression Manager in source devices manages the compression ratio based on the signal data rate requested by the displays, the allowed physical link maximum bandwidth in between, and the available source content qualities, and decide the signal data rate (compression ratio) to use for each device. The Compression Manager in display devices manages the decompression process to reconstruct the video content to match the native resolution of the screen, and the audio speaker arrangement.

### DETAILED DESCRIPTION

### XDI Systems

Provided are embodiments for the XDI (Extended Digital Interface) systems, devices, circuits, connectors, software, and methods for sending and receiving compressed audio video serial digital signals. Many of the inventions in this application can be used outside the XDI systems and devices, and are embodiments of this patent application in all such applications without limitation. The uncompressed serial digital formats like SDI, semi parallel digital formats like HDMI, DVI and DP, Internet streaming formats etc. can be converted to and from XDI format for integration in or out of an XDI system.

Referring now to FIG. 1; schematically shown is a prior art system 100 using uncompressed audio video signal format like HDMI, DP or SDI in a star topology. The 8k compressed audio video contents 101 are fed into the source devices: Internet Streaming STB 103, Cable TV STB 104, Satellite TV STB 105, 8k Blu-ray Player 106 (these are just examples; other source devices not shown are contemplated having the same functional concept as the ones shown here). These source devices decompress the originally compressed audio video signals to uncompressed ones 108 with a very high signal data rate. In this example, the 8k 60 Hz 4:4:4 is an uncompressed signal for a total 64 Gbps. This super high signal data rate reduces the useable maximum copper cable length to less than 2 meters. The signals are fed into a central matrix switcher 110 with very high bandwidth capacity (and correspondingly high cost). The matrix outputs the same uncompressed signals 112 with a very short cable length, and feed the signals to display devices: a 8k TV 114, a 4k TV 115, a 1080p TV 116, a 720 TV 117 (these are just examples; other display devices not shown are contemplated having the same functional concept as the ones shown here). Since the prior art matrix switcher 110 can only work with one signal format with one video resolution at a time, the system must choose a uniformed video resolution. In this FIG. 1, example we use the system resolution to match the highest resolution among the displays, 8k. The 8k display 114 shows a normal picture. The 4k display 115 shows a scaled down picture or no picture. The 1080p display 116 and 720p display 117 cannot show any picture.

Referring now to FIG. 2; schematically shown is the same prior art hardware system 200 as the one in FIG. 1 system 100, the only difference is now the system video resolution is chosen to match the lowest resolution among the displays, 720p. By sending this signal through the system, the data rate of the signal 208 and 212 to and from the AV matrix switcher 210 is reduced to 2 Gbps, allowing the maximum cable length to reach 30 m. Now only the 720p TV 217 shows a normal picture. All other displays 214, 215 and 216 (TVs) will show a very low resolution pictures scaled up from 720p, and this defeats the purpose of using the 8k or 4k audio video contents and displays.

Referring now to FIG. 3, schematically shown is an embodiment of the current invention XDI system 300 in Star Topology. The 8k compressed audio video content 301 are fed into XDI source devices: Internet Streaming STB 303, Cable TV STB 304, Satellite TV STB 305, 8k Blu-ray Player 306 (these are just examples; other source devices not shown are contemplated having the same functional concept as the ones shown here). These XDI source devices do NOT decompress the signals, instead they send out the same compressed signals (with only signal format changes to an embodiment of one of the XDI formats) 308. The data rate of these compressed 8k signals is only 0.2 Gbps in this example, allowing use of the low cost copper coaxial cables to send these 8k signals to as far as 1 km away. In some embodiments a XDI Node (Matrix Switcher) 310 takes in these signals, switches and splits them, and sends out the same compressed signals 312 to displays: a 8k TV 314, a 4k TV 315, a 1080p TV 316, a 720 TV 317 (these are just examples; other display devices not show are contemplated having the same functional concept as the ones shown here). Since the signals in this XDI system are not resolution (pixel) based, rather they are video vector and motion based compressed signals, the system does not have to choose only one resolution as in the prior art systems in FIG. 1 and FIG. 2. These video vector and motion based compressed signals are decompressed inside each display by its built in Compression Decoder to reconstruct the video to match the native resolution of its screen, and each display can show its optimized pictures in different resolutions from other displays from the same video vector and motion based compressed signals in the system.

Referring now to FIG. 4, schematically shown is the current invention XDI system 400 in Daisy Chain Topology. It's very similar to the system in FIG. 3, but without the central Node (Matrix Switcher) 310. All devices in this system have at least one XDI input and one XDI output for receiving and sending signals 401. Device 403's XDI output is connected to Device 404's XDI input by a single coax cable 409; Device 404's XDI output is connected to Device 405's XDI input, and so on via a single cable 419 to Devices 406, 417, 416, 415, 414. The single coax cable 411 runs between the displays. In this daisy chain system, the single coax cable in between XDI devices carries all the signals accumulated from all upstream source devices. The displays devices 414 through 417 each has its built-in Daisy Chain Processor to select with signals it extracts from the multiple signals inside the coax cable and decode for local screen. This allows the daisy chain to function as a true matrix switcher system without a matrix switcher. These video vector and motion based compressed signals are decompressed inside each display by its built in Compression Decoder to reconstruct the video to match the native resolution of its screen, and each display can show its optimized pictures in different resolutions from other displays from the same video vector and motion based compressed signals in the system.

### XDI Source Devices

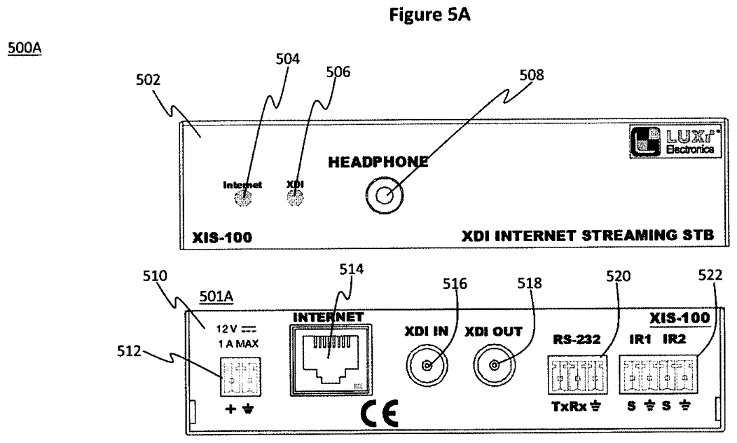

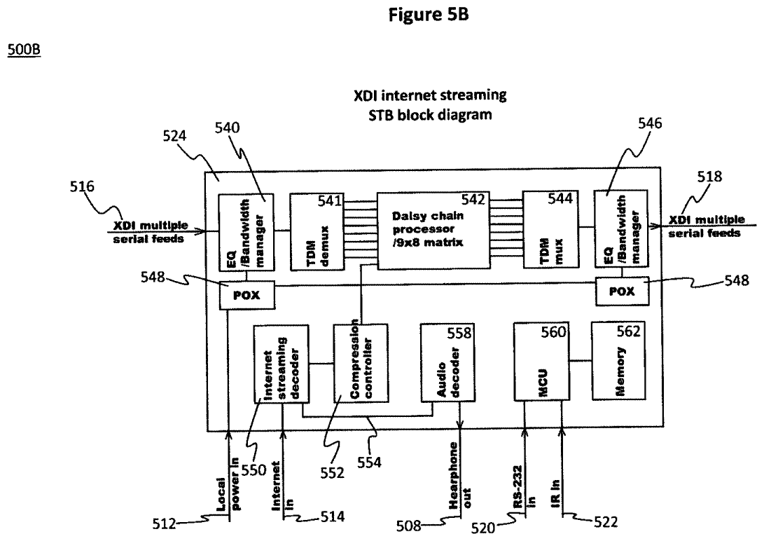

Referring now to FIG. 5A and FIG. 5B, schematically shown are XDI Internet Streaming STB source device's front panel 502 and its features 500A, rear panel 510 and its features 501A and internal circuit block diagram 500B, respectively.

Now continuing on referring to FIG. 5A and FIG. 5B. The front panel 502 has indicators for Internet 504 and XDI 506 signals as well as for a headphone connection 508. The rear panel 510 has power 512, Internet connector 514 (RJ-45), XDI in 516, XDI out 518 connectors and control RS232 520 and Infrared 522 connectors. The XDI Internet Streaming STB circuit block diagram 500B's MCU (Micro Control Unit) IC 560 together with Memory IC 562 and the local firmware and system software controls all functions of the XDI system and all internal circuits of this device, by the user input commands via RS-232 connector 520 and IR connector 522 from this device and all other connected devices, and by the system protocols. A local power source comes in via connector 512 to the POX (Power over XDI) circuit 548 sharing the power among all connected XDI devices thus the XDI system does not need for every device to be powered locally. The power is inserted into the single coax cable with the serial audio video data via phantom power technology. Note that the functions described in this paragraph are common to all XDI electronics devices and will not be repeated in the descriptions to other XDI devices below though the relevant figures show these common elements.

Now continuing on referring to FIG. 5A and FIG. 5B. The multiple XDI compressed serial feeds via a coax cable enters the device circuit board 524 via a coax connector 516. The EQ circuit 540 equalizes (amplifies) and reshapes the signals to sharp digital square waves. The Bandwidth Manager 540 works in conjunction with the Bandwidth Manager in the immediately connected device upstream to test the maximum physical link bandwidth, and also with the Compression Controller 552 in this device and all other related devices in the system to ensure the signal data rate never exceeds the physical link's maximum bandwidth. A TDM (Time Domain Multiplexing) demux (De-Multiplexer) 541 separates the multiple sets of serial audio video data in one coax cable into multiple lines that each carries one set of serial audio video data, and feeds them into a Daisy Chain Processor (Matrix Switcher) 542. The 542 takes all demuxed signals from 541, plus the serial audio video data from local source 514 (converted by decoder 550 and regulated by controller 552), chooses which upstream data are passed through to downstream devices, and which one is replaced by local data stream. A TMD mux (Multiplexer) 544 takes in the multiple lines that each carries one set of serial audio video data from the Daisy Chain Processor 542, and combines them into one line of multiple sets of serial audio video data, and feeds into EQ/Bandwidth Manager 546 and sends through a coaxial connector 518 to downstream devices. Note that all descriptions in this paragraph are common to all the daisy chain portion of the circuits of all XDI source devices with daisy chain feature, and will not be repeated in the descriptions to other XDI devices below though the relevant figures show these common elements. For the XDI source devices without daisy chain feature, the items 516, 540, 541, 542, 544 are not needed.

Now continuing on referring to FIG. 5A and FIG. 5B. The Internet signal enters the device via a RJ45 connector 514 (or wireless antenna connector, not shown), to an Internet Streaming Decoder 550, and is converted into the XDI serial digital format without decompressing, and then is fed to Compression Controller 552 which works in conjunction with Bandwidth Managers 540 and 546 to make sure the signal data rate never exceeds the physical link max bandwidth. Item 550 also de-embeds audio to signal, and feeds 554 to an Audio Decoder 558 to drive the headphone via connector 508. POX 548 (Power over XDI) provides the remote power capability.

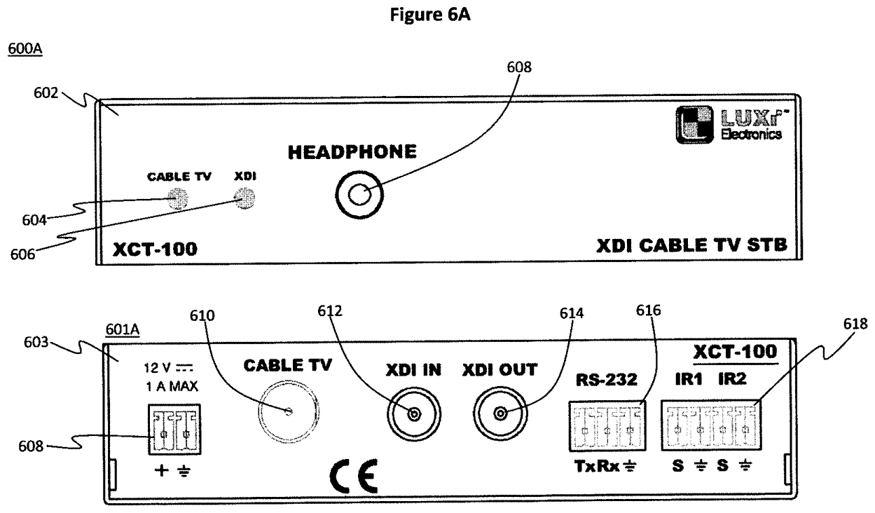

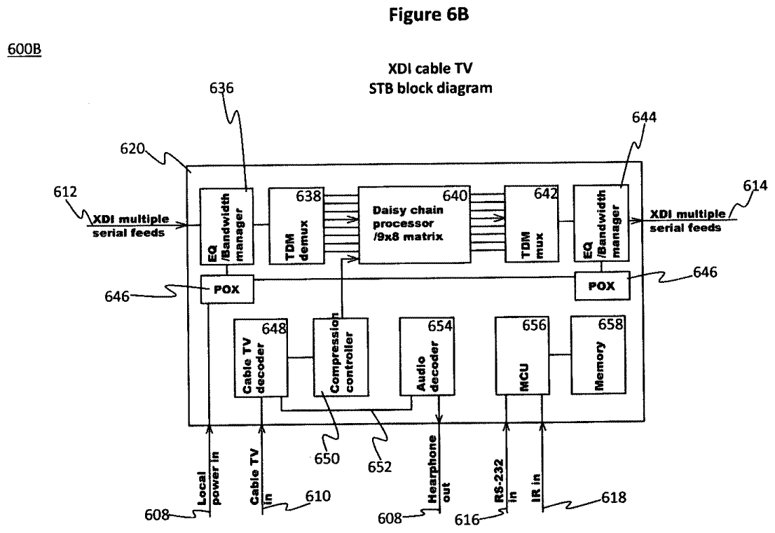

Referring now to FIG. 6A and FIG. 6B, schematically shown are XDI Cable TV STB source device's front panel 602 and its features 600A, rear panel 603 and its features 601A and internal circuit block diagram 600B, respectively. Its features and internal circuits are the same as device shown in FIG. 5A and FIG. 5B, with the only differences being the item 610 is now a coaxial connector for Cable TV input, and item 648 now is a Cable TV decoder.

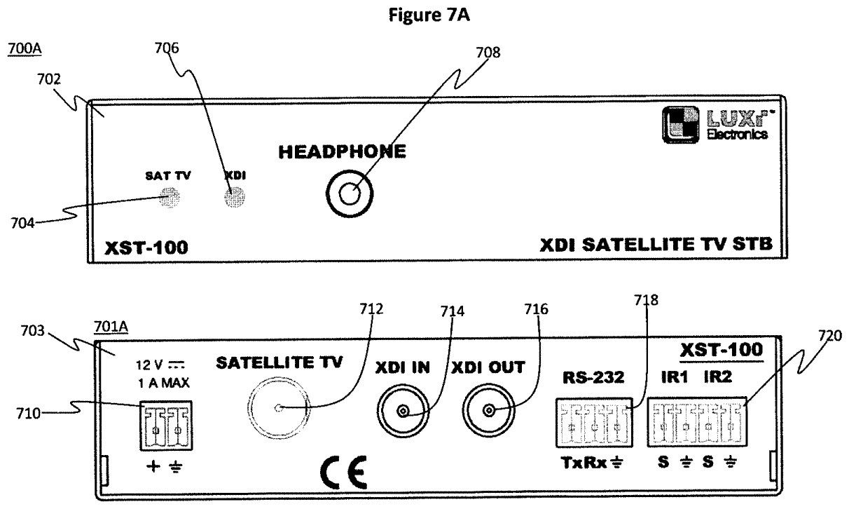

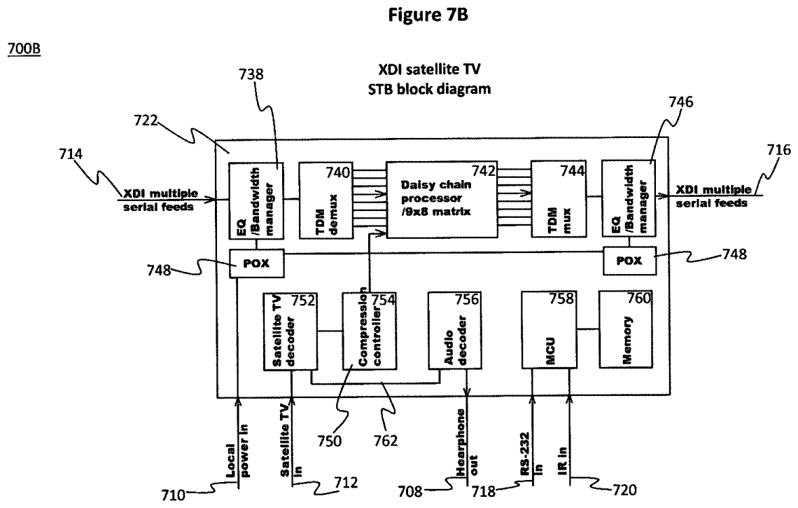

Referring now to FIG. 7A and FIG. 7B, schematically shown are XDI Satellite TV STB source device's front panel 702 and its features 700A, rear panel 703 and its features 701A and internal circuit block diagram 700B, respectively. Its features and internal circuits are the same as device shown in FIG. 5A and FIG. 5B, with the only differences being the item 712 is now a coax connector for Satellite TV input, and item 752 now is a Satellite TV decoder.

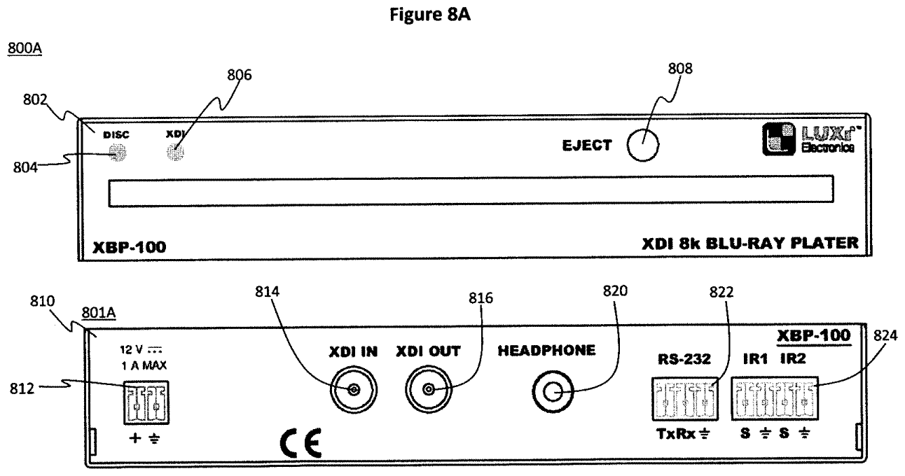

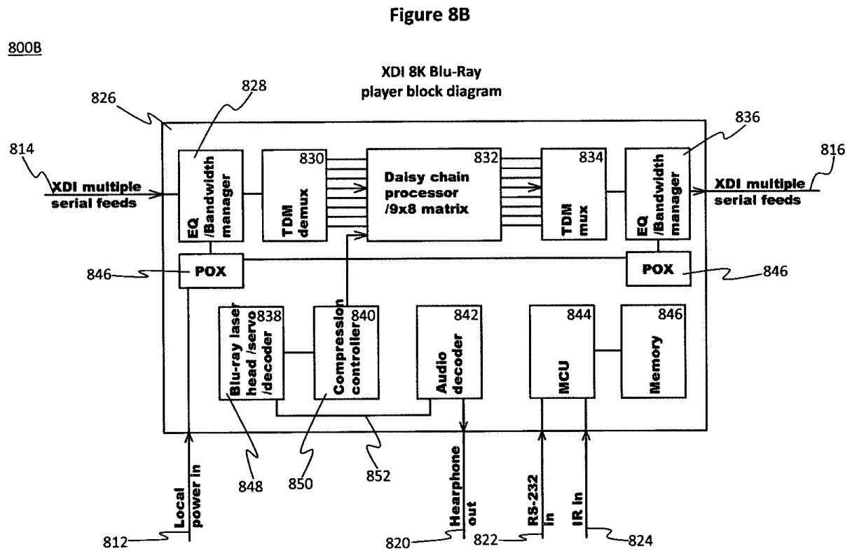

Referring now to FIG. 8A and FIG. 8B, schematically shown are XDI 8k Blu-ray Player source device's front panel 802 and its features 800A, rear panel 810 and its features 801A and internal circuit block diagram 800B, respectively. Its features and internal circuits are the same as device shown in FIG. 5A and FIG. 5B, with the only difference being the item 838 now is a Blu-Ray laser head/disc servo/decoder that includes all the mechanical, optical and electrical components of a Blu-Ray player core.

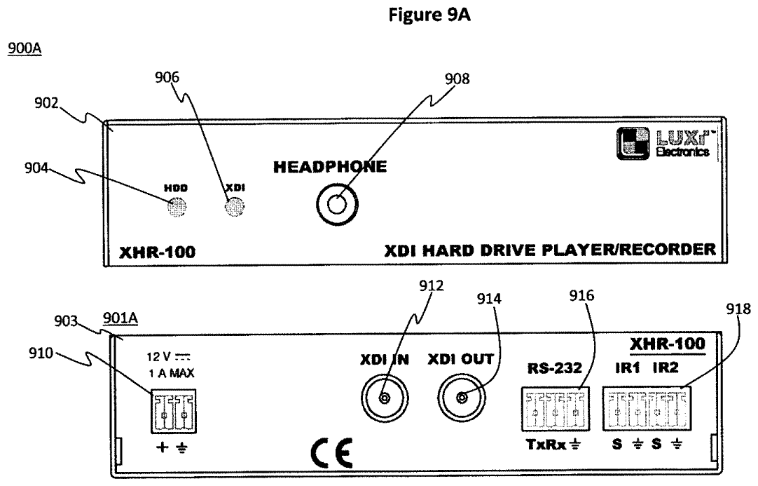

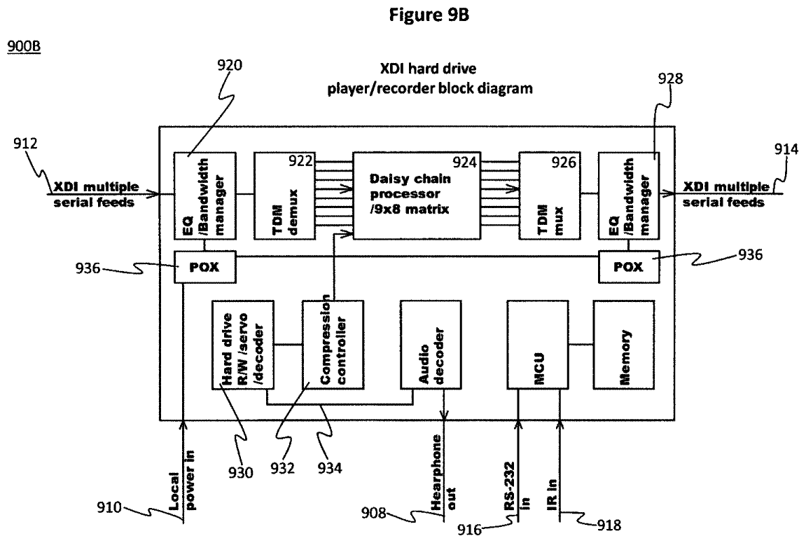

Referring now to FIG. 9A and FIG. 9B, schematically shown are Hard Drive Player/Recorder source device's front panel 902 and its features 900A, rear panel 903 and its features 901A and internal circuit block diagram 900B, respectively. Its features and internal circuits are the same as device shown in FIG. 8A and FIG. 8B, with the only difference being the item 930 now is a hard drive read/write/disc servo/decoder that includes all the mechanical, magnetic and electrical components of a hard drive player/recorder core.

### XDI Compression Encoder

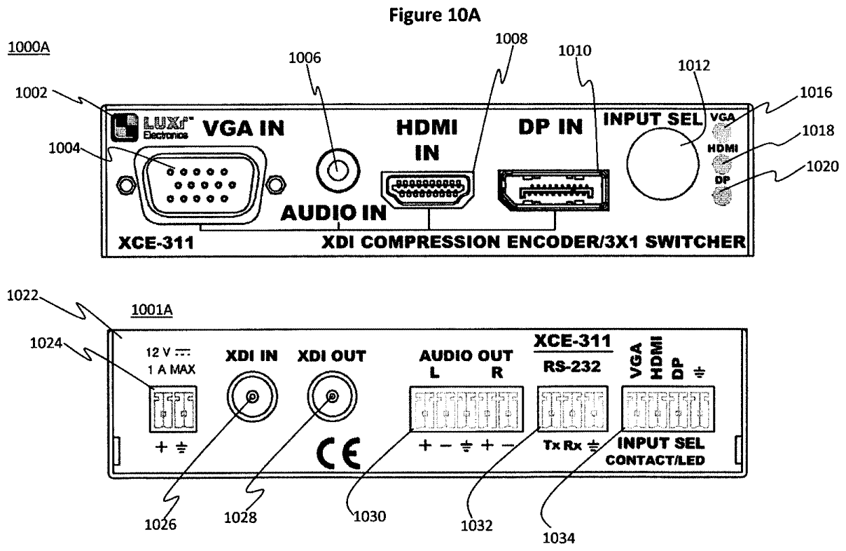

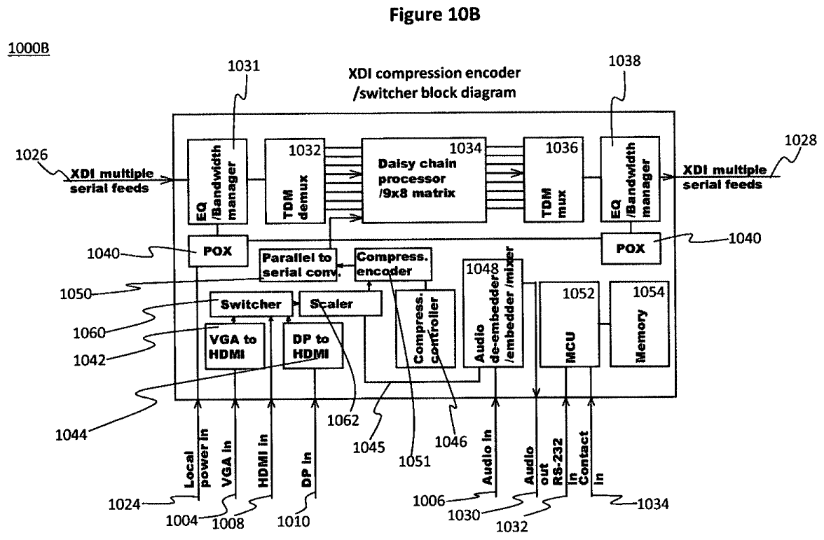

Referring now to FIG. 10A and FIG. 10B, schematically shown are XDI Compression Encoder/Switcher's front panel 1002 and its features 1000A, rear panel 1022 and its features 1001A and internal circuit block diagram 1000B, respectively. The function descriptions of item 1026, 1031, 1032, 1034, 1036, 1038, and 1028 are identical to the ones described in paragraph [0056], and also described items 1024, 1040, 1052 and 1054 in paragraph [0055], so there is no need to repeat these descriptions here. The local uncompressed signal inputs can be one or multiple. In this example we show 3 types of local uncompressed video inputs. A VGA input enters via connector 1004 to a VGA to HDMI converter 1042 to be converted into a digital format like HDMI, then is fed into a HDMI switcher 1060. A HDMI input enters via connector 1008 and directly to switcher 1060. A DP signal enters via connector 1010 to a DP to HDMI converter 1044 to be converted to HDMI, and then is fed into a switcher 1060. The switcher 1060 chooses which signal to be sent to scaler 1062 that scales the video to the requested resolution. The output from 1062 goes to Compression Encoder 1051, in which the uncompressed signals are compressed, then to Parallel to Serial Converter 1050 in which the semi parallel signals are converted to serial data. This compressed serial data goes into the Daisy Chain Processor (Matrix) 1034, and either is not used or is replaced by one of the serial data signals from upstream devices, decided by the user request. The Compression Controller 1046 works with Bandwidth Managers in all devices to determine the proper signal data rate that can meet the displays' requests while not exceeding the physical links max bandwidth, and controls the Compression Encoder 1051 to have the right compression ratio. Audio De-embedder/Embedder/Mixer 1048 gets audio signals from scaler 1062 and local audio input 1006, changes the digital audio to analog audio, switch or mix different audio inputs, and then sends out a local analog audio via audio out connector 1030, and inserts audio into digital video via scaler 1062 if needed. In some embodiments where there's only one local video input needed, item 1004 or 1008 or 1010, 1042 or 1044, 1060, 1062 are optional and are not needed. In some other embodiment where the daisy chain feature is not needed, items 1026, 1031, 1032, 1034, 1036 are not needed. In yet other embodiment where audio embedding/de-embedding is not needed, items 1006, 1048 are optional.

### XDI Compression Decoder

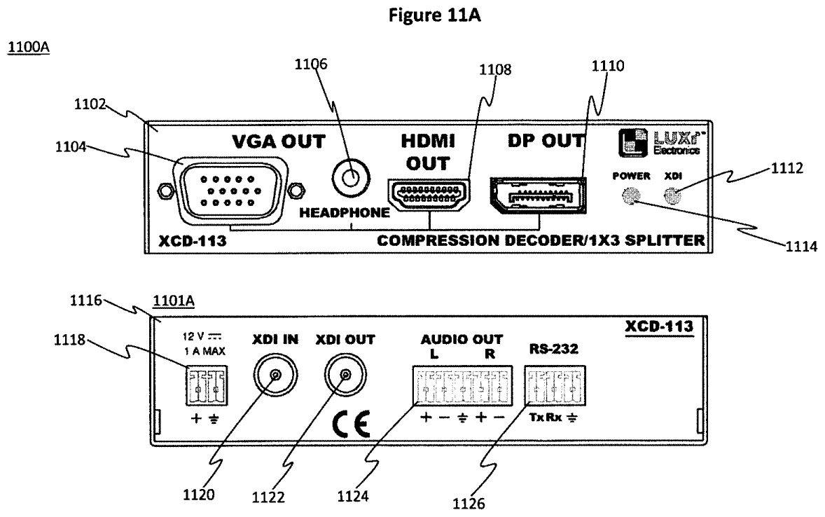

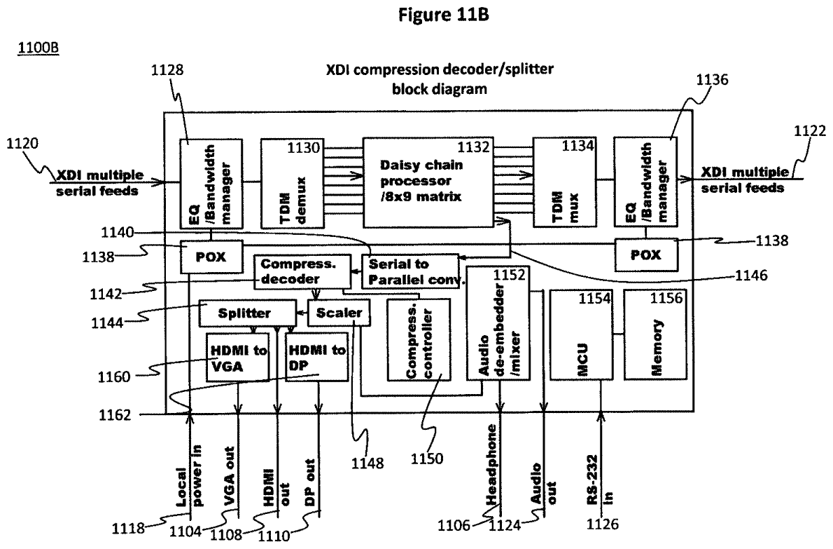

Referring now to FIG. 11A and FIG. 11B, schematically shown are XDI Compression Decoder/Splitter's front panel 1102 and its features 1100A, rear panel 1116 and its features 1101A and internal circuit block diagram 1100B, respectively. The multiple XDI compressed serial feeds via a coax cable enters the device via a coax connector 1120. The EQ circuit 1128 equalizes (amplifies) and reshapes the signals to sharp digital square waves. The Bandwidth Manager 1128 works in conjunction with the Bandwidth Manager in the immediately connected device upstream to test the maximum physical link bandwidth, and also with the Compression Controller 1150 in this device and all other related devices in the system to ensure the signal data rate never exceeds the physical link's maximum bandwidth. A TDM (Time Domain Multiplexing) demux (De-Multiplexer) 1130 separates the multiple sets of serial audio video data in one coax cable into multiple lines that each carries one set of serial audio video data, and feeds them into a Daisy Chain Processor (or Matrix Switcher) 1132. The Daisy Chain Processor (DCP) 1132 takes all demuxed signals from 1130, chooses which upstream data are passed through to downstream devices, and which one to be extracted to local serial data 1146, to be decoded for local display. A TMD mux (Multiplexer) 1134 takes in the multiple lines that each carries one set of serial audio video data from DCP 1132, and combines them into one line of multiple sets of serial audio video data, and feeds into EQ/Bandwidth Manager 1136 and sends through a coax connector 1122 to downstream devices. Note that all descriptions in this paragraph are common to all the daisy chain portion of the circuits of all XDI display devices with daisy chain feature, and will not be repeated in the descriptions to XDI display devices below though the relevant figures show these common elements. For the XDI source devices without daisy chain feature, the items 1130, 1132, 1134, 1136, and 1122 are not needed.

Continuing on referring to FIG. 11B, the functions of items 1118, 1138, 1126, 1154 and 1156 have been explained in paragraph [0055], so there is no need to repeat here, though the relevant figures show these common elements.

Continuing on FIG. 11B, the extracted signal 1146 from the Daisy Chain Processor 1132 goes into a Serial to Parallel converter 1140 being converted into parallel data. Then the signal goes into a Compression Decoder 1142 controlled by Compression Controller 1150, and is decompressed into uncompressed signals, then feeds into Scaler 1148 to be scaled to the requested resolution, then goes to a Splitter 1144, to be split into multiple identical signals. One of the split signals goes to a HDMI to VGA converter 1160 and is outputted from the VGA out connector 1104, the other signal goes directly to HDMI output connector 1108, and yet another signal goes to a HDMI to DP Converter 1162 and outputs from DP out connector 1110. In an embodiment where only one output is needed, item 1148, 1144, 1160, 1162, 1104 or 1108 or 1110 are optional. Optional Audio De-embedder/Mixer 1152 gets the digital audio signal from Scaler 1148, converts it to analog audio and drives the headphone via connector 1106.

### XDI Node (Matrix Switcher)

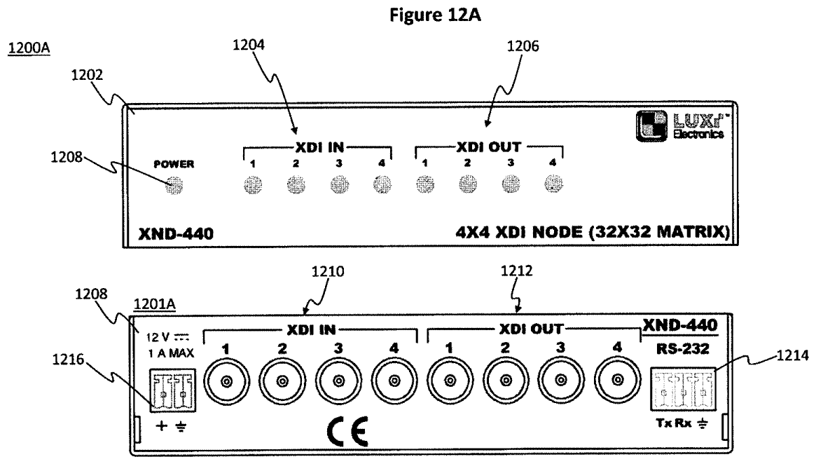

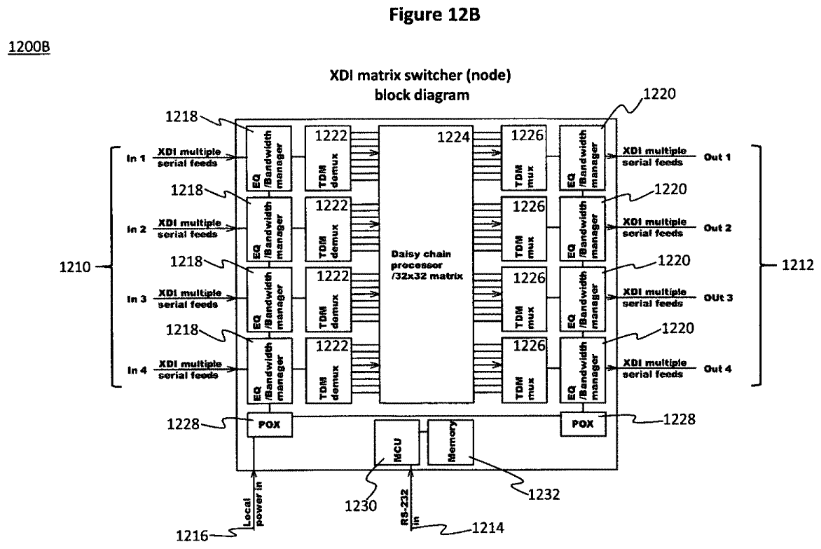

Referring now to FIG. 12A and FIG. 12B, schematically shown are XDI Compression Decoder/Splitter's front panel 1202 and its features 1200A, rear panel 1208 and its features 1201A and internal circuit block diagram 1200B, respectively. Multiple XDI coaxial cables each carry multiple sets of audio video serial data enters the device via coaxial connectors 1210 and also exits via coaxial connectors 1212. The EQ circuit 1218 on each input equalizes (amplifies) and reshapes the signals to sharp digital square waves. The Bandwidth Manager 1218 on each input works in conjunction with the Bandwidth Manager in the immediately connected device upstream to test the maximum physical link bandwidth, and also with the Bandwidth Managers in all other related devices in the system to ensure the signal data rate never exceeds the physical link's maximum bandwidth. The TDM (Time Domain Multiplexing) demux (De-Multiplexer) 1222 on each input separates the multiple sets of serial audio video data in each coaxial cable into multiple lines that each carries one set of serial audio video data, and feeds them into a Daisy Chain Processor (Matrix Switcher) 1224. The Daisy Chain Processor 1224 takes all demuxed signals from multiple TMD demux 1222s, chooses which upstream data are passed through to downstream devices via which outputs. The TMD mux (Multiplexer) 1226 for each output takes in the multiple lines that each carries one set of serial audio video data from Daisy Chain Processor 1224, and combines them into one line of multiple sets of serial audio video data for each output, and feeds it into EQ/Bandwidth Manager 1220 and sends it through a coaxial connector 1212 for each output to downstream devices. The functions of item 1216, 1228, 1214, 1230 and 1232 have been explained in paragraph [0055], and no need to repeat it here, though the relevant figures show these common elements. Please note that this is not a traditional matrix switcher because each input is not for a single set of audio video serial data from one source device, rather it is for multiple sets of audio video signals coming from a daisy chain of multiple source devices. Similarly, each output is not a single set of audio video serial data for one display, rather its multiple sets of audio video signals for multiple displays. In the example, shown in FIG. 12B, it is a 4×4 XDI node, equivalent to a 32×32 traditional matrix. Also as is common knowledge by a skilled engineer, a Switcher is a matrix switcher whose number of output is one; and a Splitter is a matrix switcher whose number of input is one. So all the descriptions of Node (Matrix Switcher) in this paragraph also covers the multiple Switchers and Splitters embodiments.

### XDI Display Devices

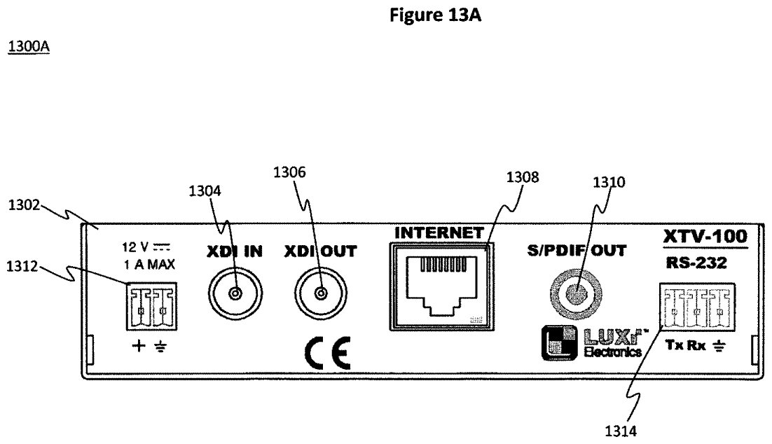

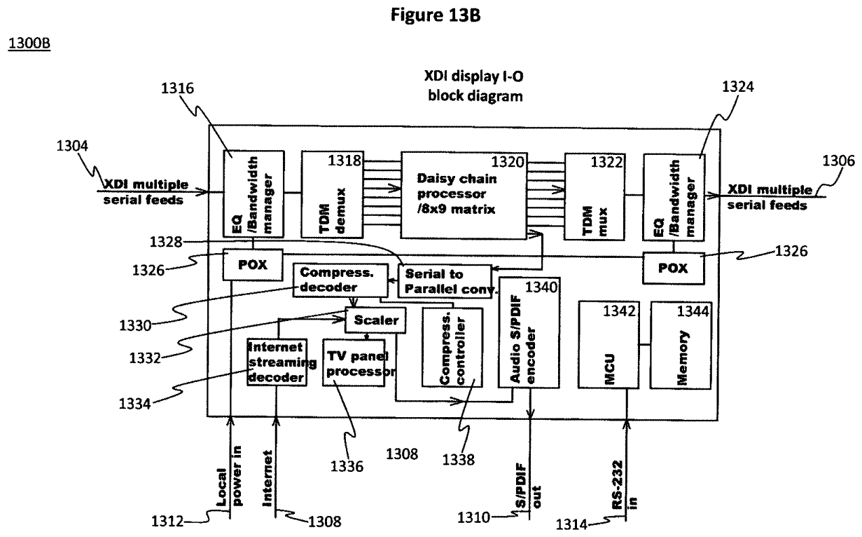

Referring now to FIG. 13A and FIG. 13B, schematically shown are XDI Display Device's I/O (Input Output) portion's rear panel 1302 and its features 1300A, and internal circuit block diagram 1300B, respectively. Once the signals converted to parallel digital signals inside a display device, the rest of the screen drive circuits or the projector panel drive circuits 1336 are part of the prior arts and there is no need to explain it further here. Thus, this section only focuses on the I/O circuits that unique to the current XDI invention.

Continuing on FIG. 13A and FIG. 13B. Item 1304, 1316, 1318, 1320, 1322, 1324, 1306, 1312, 1326, 1314, 1342 and 1344 functions the same as explained in paragraph [0063], [0064], [0065], with the only difference in 1310 and 1340, instead of a headphone analog audio output and decoder respectively, now they are S/PDIF digital audio output connector and decoder respectively. For the embodiments without XDI daisy chain feature, items 1318, 1320, 1322, 1324 and 1306 are not needed. For the embodiments without S/PDIF audio output, item 1340 and 1310 are not needed.

### Micro Coax Connectors

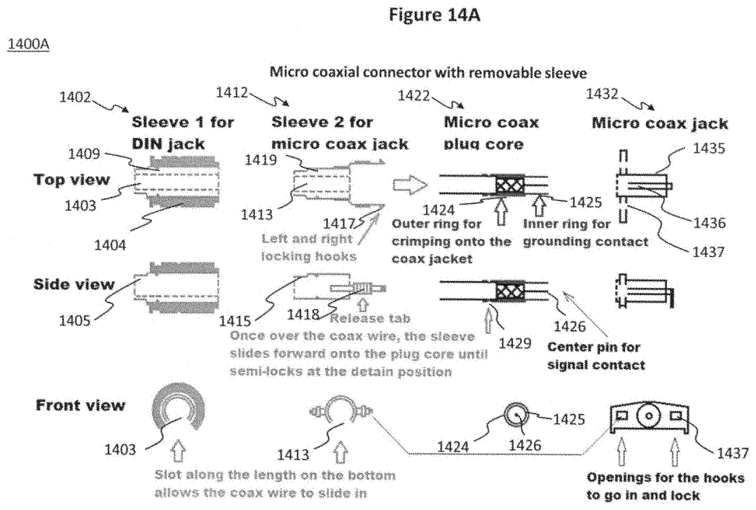

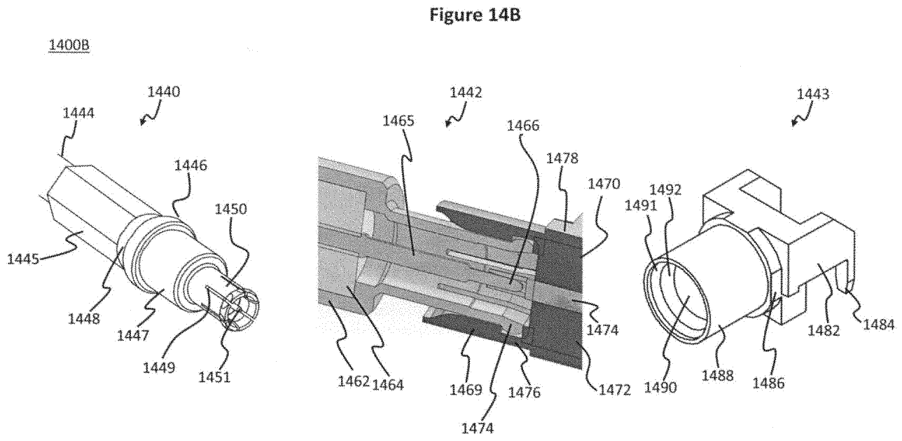

Referring now to FIG. 14A, schematically shown is an embodiment of the current invention of a micro coaxial male connector 1400 with removable sleeves and a cognate female connector. Item 1422 is the connector core for electrical contacts, which consists Center Pin 1426 from the coaxial wire for signal contact; Inner Ring 1425 inserted into the coax wire either by pushing in between the coaxial braiding and inner insulation for ground contact; Outer Ring 1424 is crimped to the coax cable jacket to create a mechanical bond, with a debossed notch ring 1429 around for semi-lock of the embossed detaining ring 1409 and 1419 described below; or by screwing in in between the coaxial braiding and inner insulation for ground contact.

Continue on FIG. 14A. Item 1402 is the current invention removable Sleeve version 1 for mating with the prior art DIN 1.0/2.3 female connectors. It has a round outer Cylinder 1404 that can lock into the DIN 1.0/2.3 female connectors; and an inter Cylinder 1405 that can slide forward onto the connector core Outer Ring 1424 with an embossed detain ring 1409 in its inner surface to be semi-locked onto the debossed notch ring 1429. A slot 1403 along the length of the Sleeve from the front to the rear ends, that allows the sleeve to slide over the coax wire before slide forward to the semi lock position when assembling the male connector; also allows the sleeve to slide back (away) from the Connector Core 1422 and slide off the coaxial wire when dissembling the male connector.

Continue on FIG. 14A. Item 1412 is the current invention removable Sleeve version 2 for mating with the current invention female micro coax connectors. It has a round cylinder 1415 that can slide onto the connector core Outer Ring 1424 with an embossed detain ring 1419 in its inner surface to be semi-locked onto the debossed notch ring 1429. The 1415 has one Locking Hook 1417 on its left side; and another Locking Hook 1417 on the right side, each with a release tab 1418 to be pushed in for unlocking. These left and right Locking Hooks goes into the matching openings 1437 on the female connector for locking. A slot 1413 along the length of the Sleeve from the front to the rear ends, that allows the sleeve to slide over the coaxial wire before slide forward to the semi lock position when assembling the male connector; also allows the sleeve to slide back (away) from the Connector Core 1422 and slide off the coax wire when dissembling the male connector.

Continue on FIG. 14A. Item 1432 is a current invention micro coaxial female connector. It has a Center Catcher 1436 for mating with Center Pin 1426 for signal contact, and a Cylinder 1435 for mating with Inner Ring 1425 for ground contact. One Opening 1437 on the left side of the Cylinder 1435, and another on the right side of 1435, for letting the two left and right Locking Hooks 1417 to slide in and hook to the outer edges. The release is achieved by pinching the left and right Release Tabs 1418 to move the Locking Hooks inward and unlock.

Referring now to FIG. 14B, schematically shown is an alternative embodiment of the current invention of a micro coaxial male connector 1400B with round locking rings and grooves. The rear flange 1445 of the male connector 1440 has similar inner ring for ground contact as the item 1425 in FIG. 14A, and is inserted into the coaxial wire 1444 by pushing and crimping or by screwing into the coax wire as described in [0071].

Continue on FIG. 14B. The male connector 1440 further consists a main body in rear 1448 and in front 1447 with a raised ring 1446 for easier hand grip.

Continue on FIG. 14B. The male connector 1440 further consists a round cylinder shaped front probe 1450 with cut gaps 1449 from the front end to near the rear end which divided the front probe into multiple separate fingers that can move independently.

Continue on FIG. 14B. The female connector 1443 consists round cylinder 1488 with the opening 1490 for accepting the male connector front probe 1450, rear connector body 1482 and ground pins 1484. The front portion of the inner side of the cylinder 1488 further consists two angled rings 1491 and 1492 at slightly different angles to guide the male connector front probe 1450 into the opening 1490.

Continue on FIG. 14B. The front edge of each finger of the male connector probe 1450 further consists a raised lip 1474; the rear end of the inner surface of the female connector cylinder 1469 further consists a debossed groove 1476. The raised lips 1474 of the front probe 1450 fingers of the male connector are pushed into the female connector cylinder 1469 until fall into the groove 1476 to create a mechanical lock. The raised lips 1474 have round edges which allows them to be pulled out of the groove 1476 with relatively strong force to release the male connector 1440 from the female connector 1443.

### Link Bandwidth Management

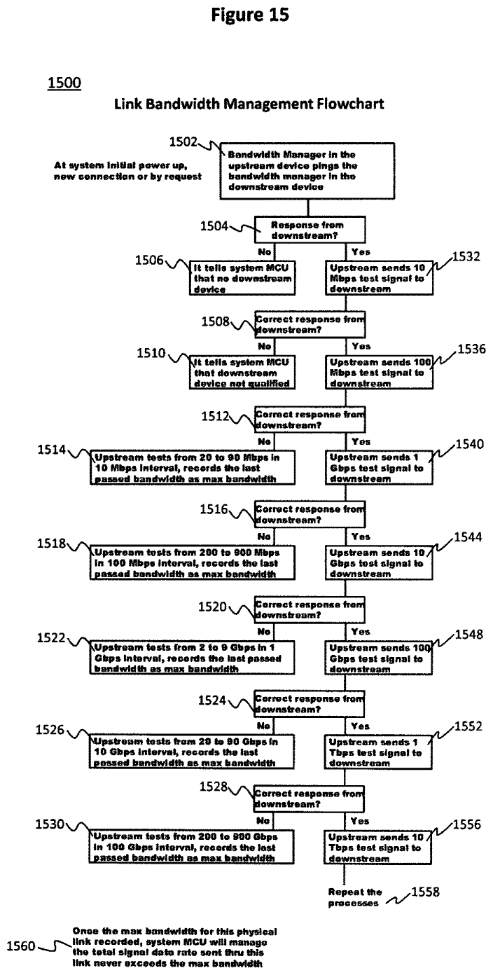

Referring now to FIG. 15 schematically shown is a representative method of Link Bandwidth Management 1500 software flowchart. At the system initial power up, new connections or by request, Step 1502 the Bandwidth Manager in the upstream device pings the one in the downstream device. Step 1504 weather a response is received or not from downstream? Step 1506 if no response from downstream, it tells system MCU that there is no downstream device. Step 1532, if there's a response, then it sends 10 Mbps (the lowest designed bandwidth) test signal to downstream device. Step 1508 correct response from downstream is received, or not? Step 1510 if no correct response from downstream, it tells the system MCU that the downstream device is not qualified. Step 1536 if a correct response is received, it sends 100 Mbps test signal to downstream. Step 1512 correct response from downstream is received or not? Step 1514 if no, it tests from 20 to 90 Mbps in 10 Mbps interval, records the last passed bandwidth as the max bandwidth for this link. Step 1540 if yes, it now sends 1 Gbps test signal to downstream in the system. Step 1516 correct response is received from downstream or not? Step 1518 if no, it tests the 200 to 900 Mbps in 100 Mbps interval, records the last passed bandwidth as the maximum bandwidth for this link. Step 1544 if yes, it sends 10 Gbps test signal to downstream in the system. Step 1520 is the correct response from downstream or not? Step 1522 if no, it tests the 2 to 9 Gbps in 1 Gbps interval, records the last passed bandwidth as the max bandwidth for this link. Step1548 if yes, it sends 100 Gbps test signal to downstream. Step1524 a correct response is received from downstream or not? Step 1526 if no, it tests the 20 to 90 Gbps in 10 Gbps interval, records the last passed bandwidth as the maximum bandwidth for this link. Step 1552 yes, it sends 1 Tbps test signal to downstream. Step 1528 correct response is received from downstream or not? Step 1530 if no, it tests the 200 to 900 Gbps in 100 Gbps interval, records the last passed bandwidth as the maximum bandwidth for this link. Step 1556 yes, it sends 10 Tbps test signal to downstream in the system to repeat the process 1558. Step 1560, once the maximum bandwidth for this physical link recorded, the system's MCU will manage the total signal data rate sent through this link lever exceeding the maximum bandwidth.

### Dynamic Vector and Motion Based Video Compression Flowchart

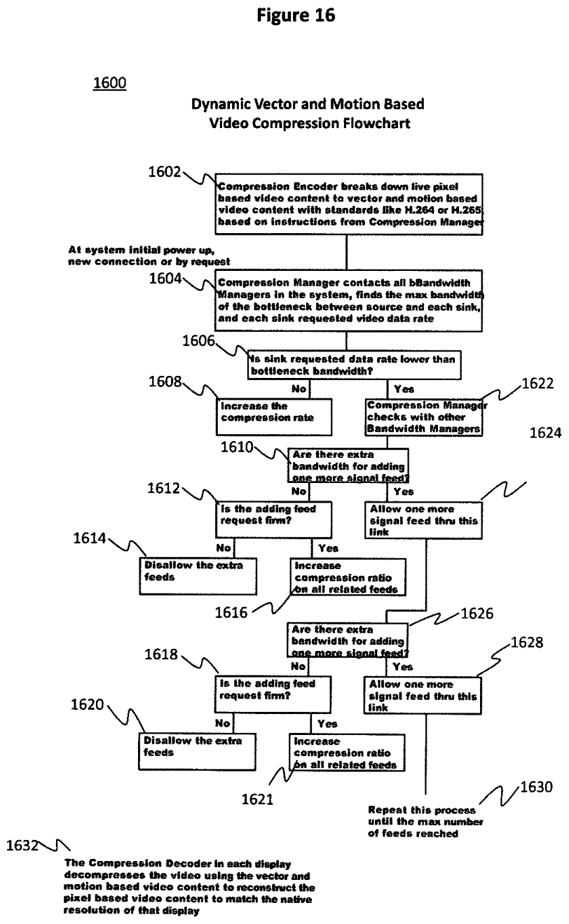

Referring now to FIG. 16 schematically shown is a representative method of Dynamic Vector and Motion Based Video Compression 1600. Step 1602 Compression Encoder recognizes the Objects from the live pixel based video content, then uses vectors to describe the Objects in each frame (intra frame compression), and uses motion to describe the Objects' movements from frame to frame (inter frame compression) using a prior art standards like H.264 or H.265, based on the instructions from the Compression Manager on the compression ratio and format. At the system level initial power up, a new connection or by request, Step 1604 Compression Manager contacts all Bandwidth Managers in the system, finds the maximum bandwidth of the bottleneck between the source and each sink, and the requested data rate (video quality) by each display device. Step 1606 is the sink (displays) requested data rate lower than link bottleneck bandwidth or not? Step 1608 no, the Compression Manager tells the Compression Encoder to increase the compression ratio (thus reduce the video quality and signal data rate) until the signal data rate is just under the link bottleneck bandwidth. Step 1622 if yes, Compression Manager checks with other Bandwidth Managers in the system further. Step 1610 are there any extra bandwidth for adding more signal feeds or not? Step 1612 if no, is the adding feed request firm (with highest priority) or not? 1614 if no, it disallows the extra feeds. Step 1616 if yes, it increases the compression ratio (thus reducing the video quality and signal data rate) on all related feeds until they all fit to the link bandwidth. Step 1624 if extra bandwidth is available, it allows one more signal feed through this link. Step 1626 if there are extra bandwidth for adding one more signal feed or not? Step 1618 if no, is the adding extra feed request firm (with highest priority) or not? Step 1620 if no, it disallows the extra feeds. Step 1621 if yes, it increases the compression ratio (thus reducing the video quality and signal data rate) on all related feeds until they all fit to the link bandwidth. Step 1628 if extra bandwidth is available, it allows one more signal feed through this link. Step 1630 repeat this process until the maximum number of feeds is reached. Step 1623 Compression Decoder in each display device decompresses the video using the vector and motion based video content to reconstruct the pixel based video content to match the native resolution of that display device.

What is claimed is:

1. A digital data transmission system comprising:
at least one device with at least one interface;
the at least one device further comprising circuitry for sending or receiving serial digital data that contains some or all of audio, video, control and other data;
wherein the serial digital data can be compressed or uncompressed; and the serial digital data can be one or more independent audio and video streams.

2. The digital data transmission system of claim 1, wherein the interface comprises a coaxial connector, RJ45 connector, fiber connector or a wireless antenna connector.

3. The digital data transmission system of claim 1, wherein the uncompressed serial digital data format is the SDI standard.

4. The digital data transmission system of claim 1, wherein the compressed video format is the H.264 standard or the H.265 standard.

5. The digital data transmission system of claim 1, wherein the at least one device further comprises a circuit board with a Bandwidth Manager that tests the actual maximum bandwidth of each physical link in the system and gives the allowed signal data rate instructions to Compression Manager for maintaining the signal data rate never exceeding the link maximum bandwidth.

6. The digital data transmission system of claim 1, wherein the at least one device further comprises a circuit board with a Compression Manager that gives instructions to a Compression Encoder on the compression ratio to be used based on the allowed signal data instructions from the Bandwidth Manager to ensure the signal data rate never exceeding the link maximum bandwidth.

7. The digital transmission system of claim 1, wherein the at least one device further comprises a circuit board with a Power over XDI circuit that sends power through the same single coaxial cable linking the devices to allow remote powering capability.

8. The digital data transmission system of claim 1, wherein the at least one device with at least one interface further comprises;
at least one input interface and at least one output interface on at least one of the at least one devices, wherein the devices are connected via a cable in a daisy-chain comprising a daisy-chain system of devices to achieve switching and distribution through the daisy chain without any additional devices for switching or distribution, and wherein the number of devices in the system is scalable by adding or reducing additional numbers of devices to the daisy-chain system of devices.

9. The daisy chain devices in clam 8, further comprising:
a TDM (Time Domain Multiplexing) demux (De-Multiplexer) circuit that converts one link of multiple sets of audio video data from upstream device into multiple links that each contains only one set of audio video data;
a Daisy Chain Processor that is a matrix switcher circuit that chooses which upstream signals to bypass for this device to the downstream device, and which upstream signal is replaced by the local signal, and which upstream signal is extracted for local display; and
a TDM mux (Multiplexer) circuit that converts multiple links that each contains only one set of audio video data to one link of multiple sets of audio video data to downstream device.

10. The digital data transmission system of claim 1, further comprising:
a Source Device, the Source Device further comprising circuitry that reads audio video data from a storage medium (e.g. disk or like device, hard drive, semiconductor memory) or from external sources like the Internet, Cable TV or Satellite TV and converts the signals to the compressed serial digital data.

11. The digital data transmission system of claim 1, further comprising:
a Compression Encoder device that further comprises a circuit board with;
a Compression Encoder circuit that compresses the uncompressed signals like HDMI, DP or SDI to compressed signals; and
a Parallel to Serial Converter circuit that converts the parallel signals to serial digital data.

12. The digital data transmission system of claim 1, further comprising:
a Compression Decoder device that further comprises a circuit board with;
a Serial to Parallel Converter circuit that converts the serial digital signals to parallel digital signals; and
a Compression Decoder circuit that decompresses the compressed signals to uncompressed signals like HDMI, DVI or DP.

13. The digital data transmission system of claim 1, further comprising:
a Node (Matrix Switcher) device that has a circuit board with;
one or more serial inputs that each carries at least one sets of audio video content;
one or more TDM (Time Domain Multiplexing) demux (De-Multiplexer) circuit that each converts one link of multiple sets of audio video data from upstream device into multiple links that each contains only one set of audio video data;
a matrix switcher circuit that chooses which upstream signals goes to which downstream outputs; and
one or more TDM mux (Multiplexer) circuit that each converts multiple links that each contains only one set of audio video data to one link of multiple sets of audio video data to downstream device.

14. The digital data transmission system of claim 1, further comprising a Display Device that has a circuit board further comprising:
a Serial to Parallel Converter circuit that converts the serial digital signals to parallel digital signals;
a Compression Decoder circuit that decompresses the compressed signals to uncompressed signals; and
a TV Panel Processor circuit that converts the uncompressed signals to the proprietary signals to drive the screen panel or projector core panels.

15. An interconnect system comprising:
a male connector for a cable;
the male connector further comprising a Connector Core for making electrical connections;
at least one removable and replaceable connector Sleeve for adapting the connector to different shaped and sized connectors;
each removable connector Sleeve further comprising;
a slot opening along the side to allow the cable to slide through;
a semi locking mechanism to lock onto the connector core when sliding forward;
a locking mechanism to lock onto a cognate female connector; and
a female connector with a matching locking mechanism to the male connector;
and at least one safety break away point.

16. The interconnect system of claim 15, wherein the cable is a coaxial cable.

17. The interconnect system of claim 15, wherein the removable connector sleeve is round shaped and the complete connector with this sleeve is compatible with the DIN 1.0/2.3 standard.

18. The interconnect system of claim 15, wherein the removable connector sleeve is oval shaped to reduced overall height from about 2 mm to about 5 mm, and wherein the connector further comprises one locking hook on the left side and another locking hook on the right side of the connector.

19. The interconnect system of claim 15, wherein the at least one safety breakaway point of the removable connector sleeve is designed to be the first to break when the cable is under strain.

20. A method for digital data transmission system comprising:
a system-wide link Bandwidth Management protocol check in which the actual maximum bandwidth of each physical link in the system is tested and the data flow assigned to that link is maintained below the actual maximum bandwidth at all times; and
a dynamic vector and motion based video content compression algorism that only allows the requested amount of data from the sink and actual maximum bandwidth of the physical link in between whichever is lower.

21. The system-wide link bandwidth management protocol in the method of digital data transmission system of claim 20, further comprising the steps of:
sending out the test signal from the device on the upper stream of a physical data link with lowest data rate first at initial power up, handshake, or by request;
waiting for the device in the other end of the physical data link to send an acknowledgement receiving an error free signal; then
increasing the test signal sent from the upper stream device with higher data rate; and
repeating the step of increasing the test signal sent from the upper stream device with higher data rate, until an error message or nor response at all is received from the downstream device and then recording the signal data rate wherein receiving the error free acknowledgement from the downstream device as the actual maximum bandwidth of this physical link.

22. The method of digital data transmission system of claim 20, further comprising;
breaking down into objects and their movements in video content for use in the compression by the compression encoder in a source device;
sending the digital data through a physical link at the requested and possible data rate; and
decompressing the signals by the Compression Decoder and reconstructing the video at the resolution to best fit to its screen, wherein the reconstructed video at each display can be different from the same serial digital video data.

23. The digital data transmission system of claim 1, further comprising a male connector and female connector for coaxial wires,
the male connector further comprising a cylinder shaped probe with an inner and outer surface with a front end and a rear end, wherein the front end the outer surface has a raised lip from the surface;
the female connector further comprising a cylinder shaped receptacle with an inner and outer surface with a front end and a rear end, wherein near the end of the inner surface of the front end has a groove cut through the surface and wherein the raised lips of the male connector fall into the groove of the female connector when the male connector is inserted fully to form a mechanical lock.
